(19) United States
(12) Patent Application Publication
(10) Pub. No.: US 2012/0253609 A1
(43) Pub. Date: Oct. 4, 2012

(54) Proportional control using state space based scheduling

(75) Inventors: Wei Li, Peoria, IL (US); Ang Qian, Lisle, IL (US); Ryan Kingdon, Peoria, IL (US); Steven Krause, Chillicothe, IL (US); Norval Thomson, Dunlap, IL (US)

(73) Assignee: CATERPILLAR INC., Peoria, IL (US)

(21) Appl. No.: 13/077,709

(22) Filed: Mar. 31, 2011

(51) Int. Cl. G06F 7/00

(52) U.S. Cl. 701/50

(57) ABSTRACT

A method for proportional state space based scheduling of gain within a machine includes generating a speed error value and when the speed error value is substantially nonzero producing an implement position difference value representing the amount by which an implement position differs from a position that would provide a desired machine speed. The method then converts the implement position difference value to a desired implement position command and differences the desired implement position command and a position signal indicative of the current implement position to produce an implement difference value. The implement difference value is used to generate one or more implement actuator signals

### TECHNICAL FIELD

This patent disclosure relates generally to industrial machine control, and more particularly to a proportional control using state space based scheduling.

### BACKGROUND

Industrial and earthmoving machines are steadily becoming more efficient, more capable, and generally less polluting. However, even the most advanced machines must still be controlled in some manner to execute a task at hand. Given the size and power of such machines, and the loads that may be involved in the operation of such machines, standard PID controllers cannot effectively control such machines to the extent desired and in some cases required.

For example, in a wheel tractor scraper (WTS), a standard PID controller may be used to control bowl movement in response to a bowl movement command so that the hydraulic system can move the bowl to maintain a desired vehicle speed. However, the error based proportional gain scheduling will not reflect the machine status well due to a number of factors. One notable shortcoming of such control schemes is that there may be substantial delays in the electronic system due to sensor sampling time. Moreover, the overall machine weight is variable, and depends upon the material loaded, which means that the machine inertia is not a constant value.

Exacerbating these problems, the standard proportional controller does not have adequate prediction capability, leading to sudden corrections and possible over and undershoot conditions. The final substantial difficulty in applying standard PID control to such machines is the fact that the machine system is generally not linear; sources of non-linearity abound, including error quantization, dead band in the hydraulic system and so on.

In order to deal with a nonlinear system, such as complicated machine systems, error based gain scheduling techniques has been widely applied to the standard PID control. Thus, although standard PID control with error based gain scheduling in the context of machines such as those mentioned above may be feasible, it does bring with it certain user-observable drawbacks stemming from the control problems noted above. For example, the machine may lug to a stop when the scraper load increases, and may launch unexpectedly after an abrupt bowl lifting. Thus, in the inventors' observation, a new system of machine control is needed for replacement of the error based gain scheduling PID control on certain machines.

### SUMMARY

In one aspect, the description includes a wheel tractor scraper with proportional state space based scheduling of gain for positioning a bowl of the wheel tractor scraper actuated by one or more bowl actuators. The wheel tractor scraper includes a controller for receiving a value indicative of the wheel tractor scraper ground speed, a value indicative of a desired ground speed, and a value indicative of the position of the bowl and for controlling the position of the bowl. The WTS further includes a non-transient computer-readable medium having computer executable instructions for execution by the controller to produce a state space based gain for positioning the bowl.

In another aspect, the disclosure illustrates a method of providing proportional state space based gain scheduling for a bowl position in a wheel tractor scraper. The method includes receiving a value indicative of the wheel tractor scraper ground speed, a value indicative of a desired ground speed, and a value indicative of the position of the bowl. A speed error value is generated based on the wheel tractor scraper ground speed and the desired ground speed, and a state space based gain is produced for repositioning the bowl. The state space has at least a first and second dimension, the first dimension being a speed error dimension and the second dimension being a speed error derivative dimension. The bowl is then repositioned based at least on the state space based gain.

In yet another aspect, a control system is provided for controlling a WTS machine, the control system including a ground speed error calculation stage for receiving an actual ground speed of the WTS and a desired ground speed of the WTS as measured from user control inputs, and producing a speed error value. An included proportional controller receives the speed error value, calculates a speed error derivative value, and produces a bowl position difference value representing an amount by which the bowl position is misaligned from one that would provide the desired speed of the WTS. A command conditioner receives the bowl position difference value and conditions the bowl position difference value into a final desired bowl position difference command corresponding to an actual desired bowl position. A bowl position corrector is provided for receiving the desired bowl position difference command and a position signal representing an actual current bowl position and producing a desired bowl position command based on the desired bowl position difference command and the position signal so that the bowl tends toward a position to minimize the speed error value.

Further and alternative aspects and features of the disclosed principles will be appreciated from the following detailed description and the accompanying drawings, of which:

### BRIEF DESCRIPTION OF THE DRAWINGS

FIG. 1 is a is simplified system diagram showing a control architecture usable in accordance with the disclosed principles;

FIG. 2 illustrates a speed error/speed error derivative chart showing a plurality of potential speed error values and a plurality of potential speed error derivative values in accordance with the disclosed principles;

FIG. 3 is a speed error derivative/error phase plane chart, the two dimensional case of the state space diagram, showing a state space trajectory from an initial machine state to the equilibrium state space origin during ordinary PID operation;

FIG. 4 is a gain map that is scheduled based on the trajectory of the machine state in state space in accordance with the described principles; and

FIG. 5 is a flow chart illustrating a process of proportional state space based implement control in accordance with the described principles.

### DETAILED DESCRIPTION

This disclosure relates to a system for executing a proportional control structure to calculate a position delta command, but using a gain scheduling schema based on a state space table that can more accurately represent machine dynamics. In overview, within the described system, the gain is scheduled based on machine state variable trajectories in the state space to provide greater stability towards a desired state. In this way, errors in position measurement are not magnified by a derivative stage of a PID control, and the machine or machine implement of interest is thus able to be more accurately and stably positioned

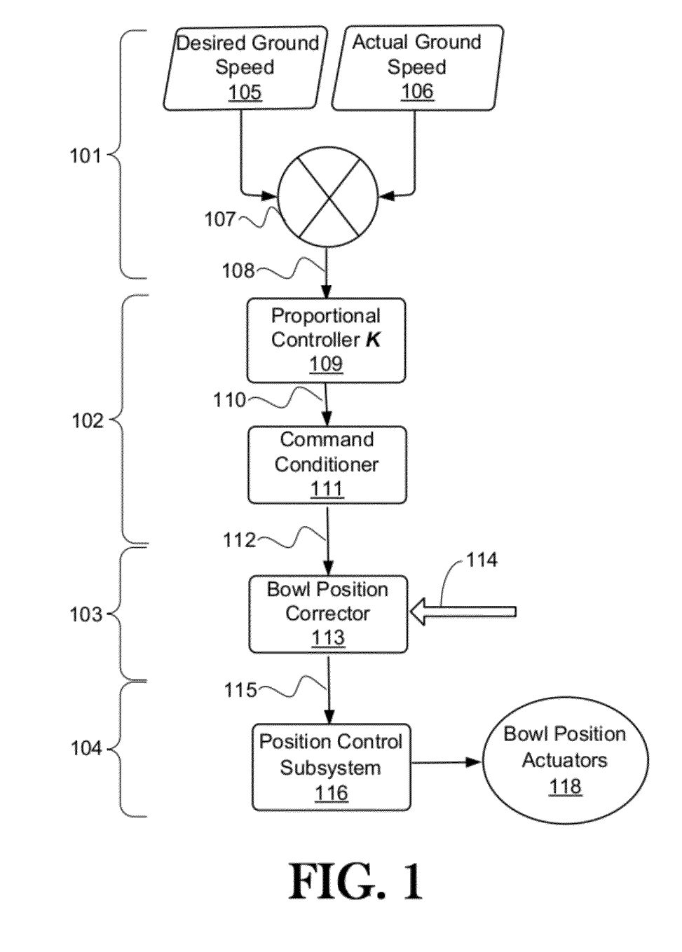

Turning now to a more detailed description of the system, FIG. 1 is a simplified system diagram showing a control architecture usable within various embodiments of the described principles in the environment of a WTS machine. The control architecture 100 includes a ground speed error calculation stage 101, a command conditioning stage 102, a bowl position error stage 103, and a bowl position controller stage 104.

The ground speed error calculation stage 101 receives an actual ground speed 105, representing the measured ground speed of the WTS, and a desired ground speed 106, as measured from user control inputs, to be input to a subtractor 107. Based on these inputs the speed subtractor 107 produces a speed error value 108. It should be noted that a non-zero speed error value 108 will not always require that the bowl be adjusted. For example, when the error is small approaching the target speed and the error derivative is small in favor of approaching the steady state speed, the system may not require any bowl adjustment, unlike a standard PID control. Rather, the system inertia can bring the system to the appropriate steady state without further correction.

A proportional controller K (109) receives the speed error value 108 and further calculates the speed error derivative value. With both the speed error value and speed error derivative, the proportional controller K (109) produces a bowl position difference value 110 representing the amount by which the bowl position is misaligned from one that would provide the desired speed. The bowl position difference value 110 is then received by the command conditioner 111, which conditions the bowl position difference value 110 into a final desired bowl position difference command 112 corresponding to an actual desired bowl position, e.g., in terms of degrees, actuator position, or other suitable measure of actual position. For example, the command conditioner 111 may add bounding limits and override to the difference command to generate the final bowl position difference command 112.

In the bowl position controller stage 104, a bowl position corrector 113 receives the final desired bowl position difference command 112 and a position signal 114 representing the actual current bowl position. By adding these inputs, the bowl position corrector 113 produces a desired bowl position command 115. A position control subsystem 116 within the bowl position controller stage 104 actuates one or more bowl actuators 118 to move the bowl to the desired bowl position corresponding to command 115. In this way, the bowl tends toward a position that will minimize the speed error value 108 as the process continues.

It will be appreciated that in specifying a bowl position, the position control subsystem 116 applies a gain value to some operative value, such as the desired bowl position command 115. While a standard PID controller would attempt to manage the bowl position by generating the derivative of the position value, such values can be error prone to the extent that they introduce instability into the system. This would in turn require the use of conservative gain values, and increase the response lag of the machine.

The introduction of machine acceleration in the gain scheduling table provides a better description of the machine state relative to the desired state, e.g., the origin or (0, 0, . . . 0) point within the state space. This improves the gain scheduling accuracy based on the machine state. When the speed error is small and acceleration is neglected, a small gain would be applied using an error-based gain scheduling approach. However, this can lead to erroneous results. For example, in a situation wherein the speed error is small but the acceleration is large, there will be a tendency to overshoot the target state. Likewise, when the speed error is small and the acceleration is a small negative number, there will be a tendency to undershoot the target or, in extreme cases, to lug down.

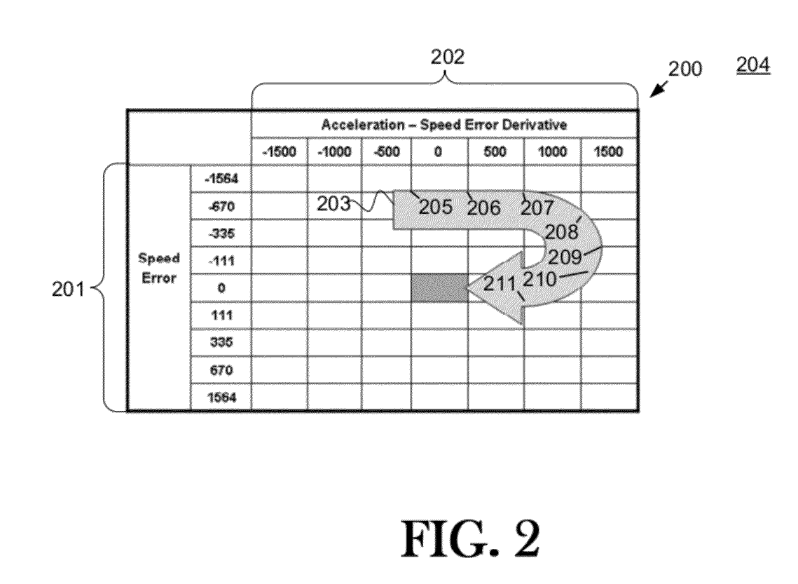

As noted above, the disclosed system instead schedules gain based on machine state variable trajectories in state space to provide greater stability towards a desired state. A situation corresponding to speed error and speed error derivative based gain scheduling is shown in chart form in FIG. 2. In particular, FIG. 2 illustrates a speed/speed error derivative chart 200 showing a plurality of potential speed error values 201 and a plurality of potential speed error derivative values 202. In the illustrated scenario, the initial state 203 of the system corresponds to a speed error of approximately −670 and a speed error derivative of approximately −250. For purposes of this illustration, the precise mechanical system and units of measurement are not important.

As can be seen, the system trajectory 204 passes through a series of speed error/speed error derivative value pairs 205-211 before settling at the origin whereat the (speed error, speed error derivative) pair is equal to (0, 0). The trajectory from the initial state 203 to the origin is an arc in the error state space, with no overshoot in the dimension of speed, i.e., with no reversal of direction.

In greater detail, the described system uses the machine state to predict the machine speed tendency and to schedule gains accordingly. Within a WTS application, the system provides compensation for the speed sensor delay. In particular, due to sampling time limitations, the speed sensor data received by the controller includes an inherent delay. In order to compensate for this delay, during lowering, the bowl of the WTS is preferably halted before the bowl position is detected to reach the target position. The bowl may also be slightly lifted when it is detected to have reached the target.

Within the WTS environment, the system also enhances operation to prevent machine stalling. In particular, in order to prevent the machine from stalling, the system actively increases applied gains when machine speed is below the target speed while the machine acceleration is negative with a large absolute value.

Moreover, since there is a closed-loop position control for the inner loop in the system, as described above, the system avoids the use of a complicated outer loop structure. In particular, the closed-loop position control for the inner loop is sufficient even when there are other nonlinearities in addition to speed sensor error or delay, e.g., slippage. While the D term in a PID controller is intended to provide prediction operation, it requires significant design accommodations and balancing between P and D, with the ever-present risk of controller instability. In contrast, the disclosed system allows a simple proportional (P) control structure which inherently provides prediction.

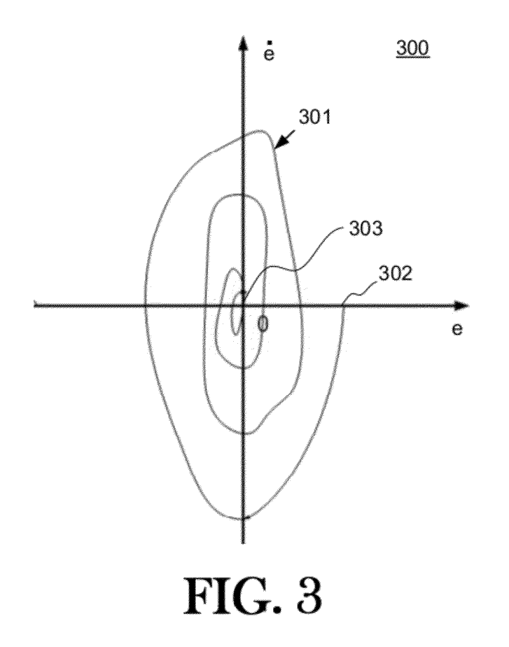

The described system also significantly outperforms PID control structures with respect to complexity of gain tuning. As discussed above, in the present system, the tuning of the gain map is directly correlated to the trajectory of the machine state in the state space. The trend of the map follows from the trace of the machine motion. FIG. 3 is a speed error derivative/velocity error state space diagram 300 showing a state space trajectory 301 from an initial machine state 302 to the state space origin 303 (0,0) during ordinary PID operation. As can be seen, the speed error derivative and velocity error swing both positive and negative during the traversal from the initial machine state 302 to the state space origin 303.

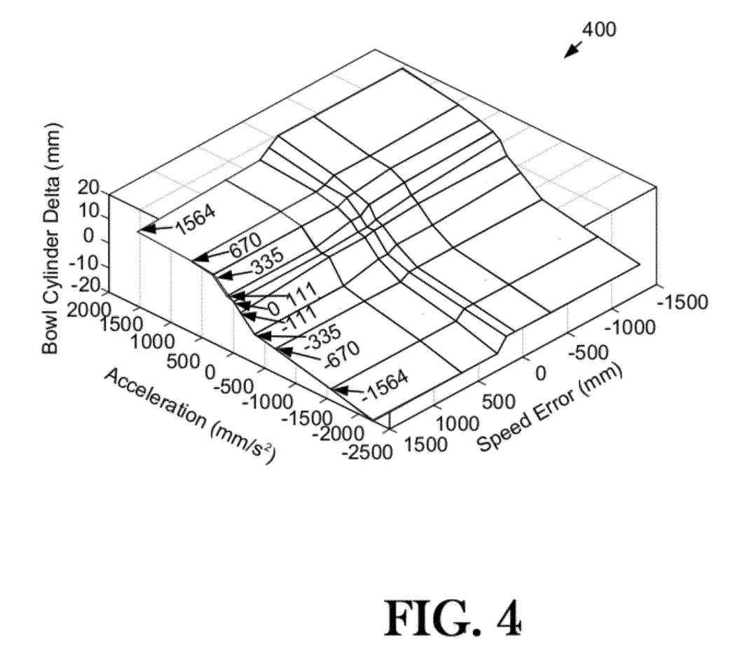

As noted above, the described system reduces the complexity of gain tuning, since the gain map is correlated to the trajectory of the machine state in the state space. Such a gain map 400 can be seen in FIG. 4, wherein the numerical annotations on the map itself denote column breakpoint values. The three dimensions of the illustrated state space are (a) bowl cylinder delta (mm), (b) WTS acceleration-speed error derivative (mm/s²), and (c) WTS speed error (mm/s). The bowl cylinder delta in the illustrated example is an amount by which the bowl cylinder commanded position should be augmented.

Thus, as a general example to understand the operation of the gain scheduling based on the map 400, if the WTS acceleration is negative and the WTS speed is less than the desired speed (and thus the speed error is negative), then the scheduled gain is such as to decrease the depth of the bowl position. In contrast, if the speed error is positive and the acceleration is positive, then the scheduled gain from the map 400 is such as to increase the depth of the bowl position.

It will be appreciated that the aforementioned mapping and control are executed by the processor or computer execution of computer-executable instructions stored on a non-transient computer-readable medium, such as RAM, ROM, flash drive, optical drive, EPROM, etc. Thus, for example, the process may be executed by a dedicated controller, by an ECU, by a TCU, etc., and may be performed by a single processor or by multiple processors, together or in different units. For clarity, the executing entity will be referred to as the controller.

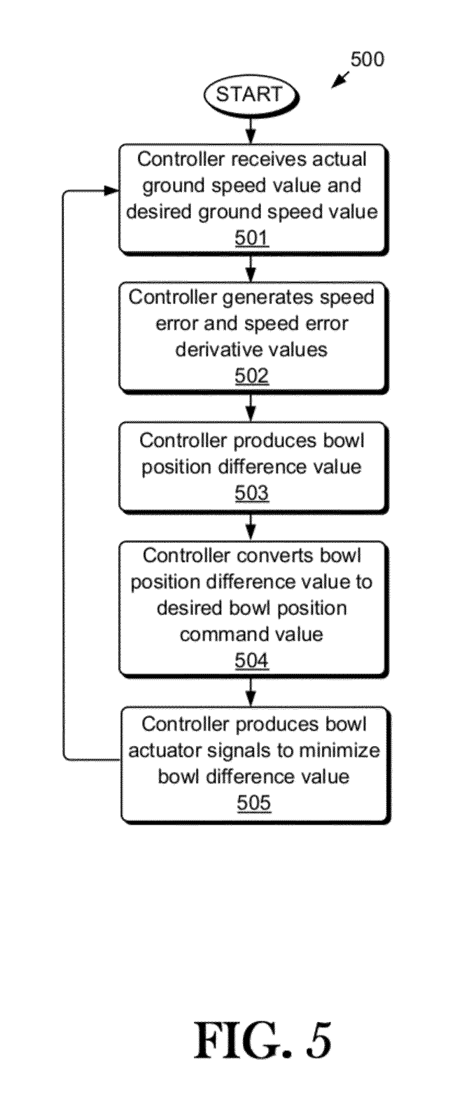

Although those of skill in the art will appreciate that there are numerous ways in which to implement the described principles, the bowl control process 500 shown in the flow chart of FIG. 5 illustrates one exemplary implementation. At stage 501 of the bowl control process 500, the controller receives a value representing an actual ground speed of the WTS as well as value representing a desired ground speed. At stage 502, and based on the received values, the controller generates a speed error value and the speed error derivative value.

With the speed error and speed error derivative values, the controller produces a bowl position difference value at stage 503 representing the amount by which the bowl position is misaligned from a position that would provide the desired speed. At stage 504, the bowl position difference value is converted to a desired bowl position command indicative of the actual desired bowl position.

However, the bowl actuator is typically a hydraulic actuator that responds to a hydraulic pressure difference rather than to an actual position command. Thus, at stage 505, the controller produces one or more bowl actuator signals to actuate one or more bowl actuators to move the bowl to the desired bowl position so that the bowl tends toward a position that will minimize the speed error value. Once the bowl position adjustment is made, the bowl control process 500 returns to stage 501 to await updated speed values and make further corrections to the bowl position as needed.

### INDUSTRIAL APPLICABILITY

The described system and principles are applicable to machines that control one or more operating variables such as a bowl or blade actuator pressure, to maximize or minimize an operating parameter such as speed. Within such applications, the described principles apply to systems wherein the operating variable and operating parameter can be related in state space.

Although the description focuses primarily on a WTS system, it will be appreciated that there are many machines, whether in industry, construction, mining, or otherwise, that can benefit from application of the described implementations and principles. For example, in the WTS system, the bowl position affects machine speed, and likewise in a grader system, the blade position would affect machine speed. Other systems include bulldozer systems wherein a blade height may affect forward speed or engine speed, and locomotive applications wherein braking pressure is related to wheel speed within a certain band to avoid ineffective braking on the one hand and wheel lock on the other hand. Other examples will be readily apparent to those of skill in the art.

It will be appreciated that the foregoing description provides useful examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. For example, the illustrated calibration steps may optionally be executed in reverse order, and other alternative orders and steps may be practicable where logically appropriate without departing from the described principles.

We claim:

1. A wheel tractor scraper with proportional state space based scheduling of gain for positioning a bowl of the wheel tractor scraper, the bowl being actuated by one or more bowl actuators, the wheel tractor scraper comprising:
a controller for receiving a value indicative of the wheel tractor scraper ground speed, a value indicative of a desired ground speed, and a value indicative of the position of the bowl and for controlling the position of the bowl; and
a non-transient computer-readable medium having thereon computer executable instructions for execution by the controller to produce a state space based gain for positioning the bowl.

2. The wheel tractor scraper according to claim 1, wherein the instructions to produce a state space based gain for positioning the bowl include instructions for generating a speed error value representing an extent to which the wheel tractor scraper ground speed varies from the desired ground speed.

3. The wheel tractor scraper according to claim 2, wherein the instructions to produce a proportional state space based gain for positioning the bowl further include instructions for calculating a derivative of the speed error value.

4. The wheel tractor scraper according to claim 3, wherein the instructions to produce a state space based gain for positioning the bowl further include instructions for producing a bowl position difference value based on a state space mapping of the speed error and speed error derivative values, the bowl position difference value representing an amount by which the bowl position is misaligned from a position that would provide the desired speed.

5. The wheel tractor scraper according to claim 4, wherein the instructions to produce a state space based gain for positioning the bowl further include instructions for modifying the bowl position difference value to a desired bowl position command indicative of an actual desired bowl position.

6. The wheel tractor scraper according to claim 5, wherein the instructions to produce a state space based gain for positioning the bowl further include instructions for producing, based on the desired bowl position command, one or more bowl actuator signals to actuate one or more bowl actuators to move the bowl to the desired bowl position so that the bowl tends toward a position that will minimize the speed error value.

7. The wheel tractor scraper according to claim 4, wherein the state space mapping of the speed error and speed error derivative values is a 2D mapping.

8. The wheel tractor scraper according to claim 4, wherein the state space mapping of the speed error and speed error derivative values is a 3D mapping.

9. The wheel tractor scraper according to claim 5, wherein the instructions for modifying the bowl position difference value to a desired bowl position command indicative of an actual desired bowl position include instructions for imposing one or more bounding limits on the bowl position difference value.

10. The wheel tractor scraper according to claim 9, wherein the instructions for modifying the bowl position difference value to a desired bowl position command include instructions for adding the desired bowl position difference command to the value indicative of the position of the bowl.

11. A method of providing proportional state space based gain scheduling for a bowl position in a wheel tractor scraper, the method comprising:
receiving a value indicative of the wheel tractor scraper ground speed, a value indicative of a desired ground speed, and a value indicative of the position of the bowl;
generating a speed error value based on the received value indicative of the wheel tractor scraper ground speed and the value indicative of the desired ground speed; and
producing a state space based gain for modification of a signal for repositioning the bowl, wherein the state space has at least a first and a second dimension, the first dimension being a speed error dimension and the second dimension being a speed error derivative dimension; and
repositioning the bowl based at least on the state space based gain.

12. The method of providing proportional state space based gain scheduling according to claim 11, wherein the speed error value represents an extent to which the wheel tractor scraper ground speed varies from the desired ground speed.

13. The method of providing proportional state space based gain scheduling according to claim 11, wherein producing a state space based gain includes producing a bowl position difference value based on the state space mapping of the speed error and speed error derivative values, the bowl position difference value representing an amount by which the bowl position is misaligned from a position that would provide the desired speed.

14. The method of providing proportional state space based gain scheduling according to claim 13, further including modifying the bowl position difference value to a desired bowl position command indicative of an actual desired bowl position.

15. The method of providing proportional state space based gain scheduling according to claim 14, wherein repositioning the bowl based on at least the state space based gain includes producing one or more bowl actuator signals to actuate one or more bowl actuators to move the bowl to the desired bowl position so that the bowl tends toward a position that will minimize the speed error value.

16. The method of providing proportional state space based gain scheduling according to claim 13, wherein the state space mapping of the speed error and speed error derivative values is a 3D mapping.

17. A control system for controlling a WTS (wheel tractor scraper) machine comprising:
a ground speed error calculation stage for receiving an actual ground speed of the WTS and a desired ground speed of the WTS and producing a speed error value;
a proportional controller for receiving the speed error value and calculating a speed error derivative value and producing a bowl position difference value representing an amount by which the bowl position is misaligned from one that would provide the desired speed of the WTS;
a command conditioner for receiving the bowl position difference value and conditioning the bowl position difference value into a final desired bowl position difference command corresponding to an actual desired bowl position; and
a bowl position corrector for receiving the desired bowl position difference command and a position signal representing an actual current bowl position and producing a desired bowl position command based on the desired bowl position difference command and the position signal so that the bowl tends toward a position to minimize the speed error value.

18. The control system for controlling a WTS according to claim 17, wherein the WTS is associated with an operator providing inputs to the WTS, and wherein the desired ground speed of the WTS is measured from the operator inputs.

19. The control system for controlling a WTS according to claim 17, further comprising a position control subsystem to actuate one or more bowl actuators to move the bowl to the desired bowl position based on the desired bowl position command.

20. The control system for controlling a WTS according to claim 17, wherein the command conditioner is configured to add bounding limits to generate the final bowl position difference command.
